(19) United States
(12) Patent Application Publication
(10) Pub. No.: US 2013/0143172 A1
(43) Pub. Date: Jun. 6, 2013

(54) HIGH THROUGHPUT FURNACE

(71) Applicant: Wildcat Discovery Technologies, Inc., San Diego, CA (US)

(72) Inventors: Steven Kaye, San Diego, CA (US); Mark Gresser, San Diego, CA (US)

(73) Assignee: Wildcat Discovery Technologies, Inc., San Diego, CA (US)

(21) Appl. No.: 13/665,962

(22) Filed: Nov. 1, 2012

Related U.S. Application Data
(60) Provisional application No. 61/566,041, filed on Dec. 2, 2011.

(51) Int. Cl. F27B 9/16; F27D 3/12; F27B 9/38; F27D 9/00

(52) U.S. Cl. 432/85; 432/122; 432/239

(57) ABSTRACT

A continuous furnace has a housing defining an interior chamber, and a plurality of endless rotatable devices within the interior chamber arranged in a series of rows with multiple ones of the endless rotatable devices in each of the rows. Multiple heaters are within the interior chamber adjacent to the plurality of endless rotatable devices. A drive system is configured to drive at least some of the endless rotatable devices at different speeds than others of the endless rotatable devices. Nozzles may be used to dispense fluid onto material sample containers passing through the furnace along the endless rotatable devices.

### CROSS-REFERENCE TO RELATED APPLICATION

U.S. Provisional Application No. 61/566,041 filed on Dec. 2, 2011 is hereby incorporated by reference in its entirety.

### TECHNICAL FIELD

The present teachings generally include a heat-treating furnace with a plurality of belts.

### BACKGROUND

A continuous furnace has a belt that moves items to be heated through the furnace. When producing metal alloys, ceramics, and/or other solid state materials, material samples must often be heated under complex temperature profiles to generate the desired product with the appropriate phase and micro-structure. The time required to heat and cool the samples can prevent rapid synthesis and screening of such materials. Existing high throughput/combinatorial furnaces operate via batch processing, which has numerous drawbacks. For example, such systems typically have a large thermal mass, necessitating long heating and cooling times. To provide heating at a required temperature profile in these systems, a separate heater and chamber is required for each small batch of samples to be treated at that profile. Large capital expenses are incurred to enable processing of a sufficient number of samples needed for a desired number of products. Furnaces currently used for heat-treating material samples do not reflect the conditions of standard industrial heat treatment processes. It can be very expensive to customize a furnace so that it will provide a specific desired heat treatment process.

### SUMMARY

To address these problems, a continuous furnace is provided that has a housing defining an interior chamber, and a plurality of endless rotatable devices within the interior chamber. As used herein, “endless rotatable devices” include belts, chains, and gears. The endless rotatable devices are arranged in a series of rows, with multiple endless rotatable devices in each of the rows. Multiple heaters are within the interior chamber adjacent to the plurality of endless rotatable devices. The heaters may be configured to provide or may be controllable to provide different intensities of heat. A drive system is operable to drive at least some of the endless rotatable devices at different speeds than others of the endless rotatable devices. This enables different desired temperature profiles to be realized for heating of different material samples in the furnace. The speeds of the endless rotatable devices can be controlled to achieve a highly customized temperature profile, as a material sample will pass by the heaters in the interior chamber at different speeds depending on which of the endless rotatable devices the material sample container rides on.

The drive system can have multiple motors so that each row of endless rotatable devices can be controlled to a speed independent of the speeds of the other rows. Alternatively, in one embodiment, only one motor is used to drive all of the endless rotatable devices through a gear train. Speeds of the endless rotatable devices will vary at speed ratios relative to one another established by gear ratios of the gear train.

The furnace may also have a plurality of nozzles within the chamber that are operable to spray fluid generally toward the plurality of endless rotatable devices. When one or more material sample containers are carried through the interior chamber by the endless rotatable devices, the fluid contacts the material sample containers, which cools or quenches the material samples. The nozzles may be configured so that at least one of the nozzles sprays fluid at a different flow rate or pressure than another one of the nozzles. A fluid distribution system may direct different fluids to the different nozzles. Accordingly, the quenching process of the material samples is also highly customizable to obtain the desired temperature profiles.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic cross-sectional illustration of a first embodiment of a high throughout furnace taken at the lines 1-1 in FIG. 5.

FIG. 2 is a schematic illustration in fragmentary side view of one of the motors of FIG. 1 used for driving one of the belts via a set of pulleys and a drive belt.

FIG. 3 is a schematic cross-sectional illustration of a second embodiment of a high throughout furnace.

FIG. 4 is a schematic illustration in fragmentary side view of the single motor of FIG. 3 used for driving all of the belts of FIG. 3 via pulleys, drive belts, and a gear train.

FIG. 5 is a schematic illustration in cross-sectional view of the rows of belts in the furnace taken at the lines 5-5 in FIG. 1, with nozzles shown in phantom positioned adjacent one of the rows of belts.

### DETAILED DESCRIPTION

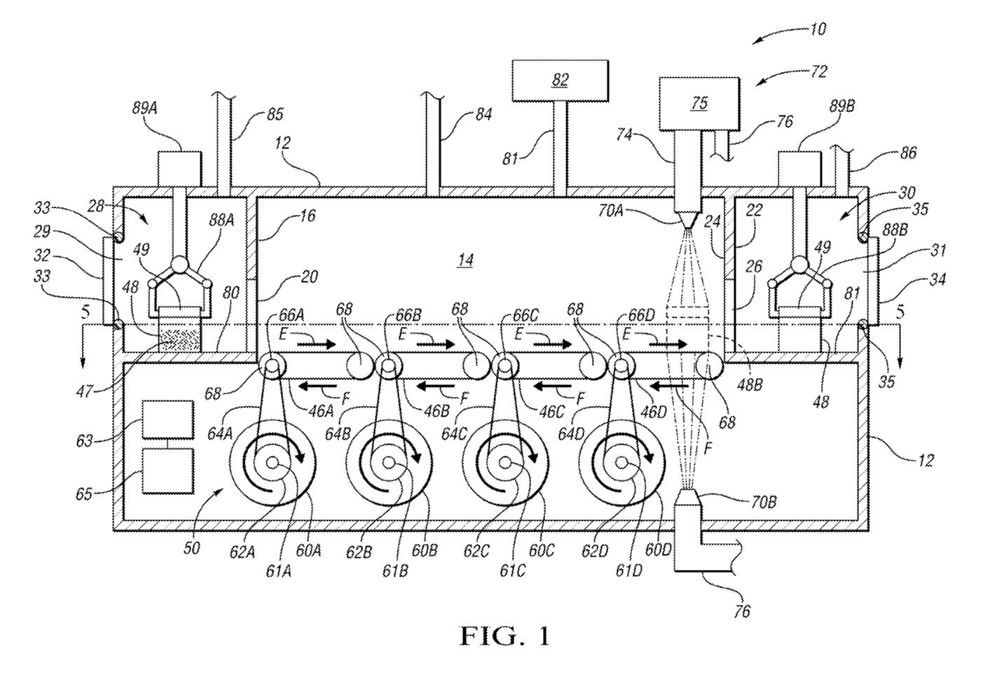

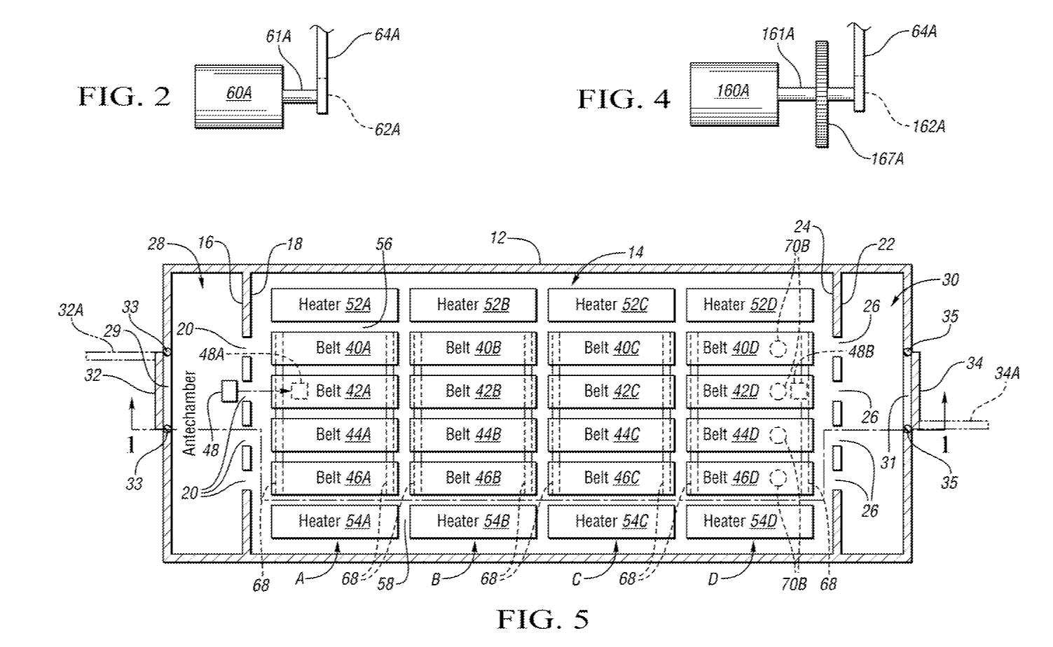

Referring to the drawings, wherein like reference numbers refer to like components throughout the several views, FIG. 1 shows a high throughout furnace 10 able to heat-treat many material samples simultaneously, enabling different temperature profiles to be experienced by different material samples simultaneously. The furnace 10 is described herein as used for heat treating material samples to be used in subsequent testing of the materials. However, the use of the furnace 10 is not limited to the heat-treatment of material samples. The furnace 10 can be used to heat-treat any items according to a process requiring a controlled temperature profile.

The furnace 10 has a housing 12 that includes all of the structure defining the outer surfaces of the furnace 10. The housing 12 has walls of any material able to withstand a high range of temperatures. For example, the housing 12 may be a heavy gauge steel. The housing 12 defines an interior chamber 14 in which material samples are heat-treated as discussed below. The housing 12 includes a first wall 16 and a second wall 22. The first wall 16 is positioned at a first end 18 of the interior chamber 14, as shown in FIGS. 1 and 5. The first wall 16 has a first set of spaced openings 20 near a lower portion of the first wall 16. A second wall 22 is positioned at a second end 24 of the interior chamber 14. The second wall 22 has a second set of spaced openings 26 near a lower portion of the second wall 22.

The housing 12 defines a first antechamber 28 separated from the interior chamber 14 by the first wall 16. The housing 12 also defines a second antechamber 30 separated from the interior chamber 14 by the second wall 22. A first door 32 is hinged to the housing 12 and can be moved to an open position 32A shown in phantom in FIG. 5 to allow access to the first antechamber 28 through a door opening 29. In the closed position, the first door 32 is sealed to the housing 12 by a seal 33 that surrounds the door opening. A second door 34 is hinged to the housing 12 and opens as shown in FIG. 5 with the door 34 shown in an open position 34A to allow access to the second antechamber 30 through a door opening 31. In the closed position, the second door 34 is sealed to the housing 12 by a seal 35 that surrounds the door opening.

The furnace 10 has multiple rows of endless rotatable devices within the interior chamber 14 that are used to move material samples through the interior chamber 14 from the first antechamber 28 to the second antechamber 30. In this embodiment, the endless rotatable devices are belts. In other embodiments, the endless rotatable devices may be chains, gears, or a combination of belts, chains and gears. As shown in FIG. 5, the furnace 10 has four rows A, B, C, and D of belts, but fewer or more rows of belts may be used. The first row A includes belts 40A, 42A, 44A, 46A. The second row B includes belts 40B, 42B, 44B, 46B. The third row C includes belts 40C, 42C, 44C, 46C. The fourth row D includes belts 40D, 42D, 44D, 46D. The belts are thus arranged both in parallel and in series. All of the belts in a given row are in parallel. The rows A, B, C, D are arranged in series. Accordingly, belts 40A, 40B, 40C, and 40D are in series with one another. Belts 42A, 42B, 42C, and 42D are in series with one another. Belts 44A, 44B, 44C, and 44D are in series with one another. Belts 46A, 46B, 46C, and 46D are in series with one another.

All of the belts are driven to rotate by a belt drive system 50 so that the sides of the belts facing the interior chamber 14 move in a direction of arrows E toward the second antechamber 30, and the sides of the belts facing away from the interior chamber 14 move in the direction of arrows F as shown in FIG. 1. All of the belts 40A-46D rotate in a clockwise direction as viewed in FIG. 1. A material sample container 48 containing a material sample 47 is placed on a belt in the first row A and is moved by the belts to the fourth row D. For example, a material sample container 48 placed in the first antechamber 28 can be moved as described below to one of the belts, such as belt 42A, as shown in phantom at 48A. The material sample container 48 will travel along the belts 42B, 42C, 42D aligned in series with belt 42A in order, and can be removed from belt 42D, on which it is represented at 48B, to the second antechamber 30 as described below.

FIG. 5 shows a plurality of heaters within the interior chamber 14 adjacent each of the rows of belts. Heaters 52A, 52B, 52C, 52D are arranged on a first side 56 of the rows A, B, C, D, respectively, just above the upper surface of the belts. Heaters 54A, 54B, 54C, 54D are arranged on a second side 58 of the rows A, B, C, D just above the upper surface of the belts. The heaters 52A-52D and 54A-54D can be resistive heaters or any other type of heater. In one embodiment, the heaters 52A-52D and 54A-54D are configured to heat material samples passing through the interior chamber 14 to a desired temperature up to approximately 1200° C. The heaters 52A-52D and 54A-54D can be configured to provide heat at different intensities. As used herein, heat intensity is quantified by the temperature of air or other gas or gases at a given distance from a heater after the heater is energized for a predetermined period of time. The heaters 52A, 52B, 52C and 52D can be resistive heaters each of a different resistance to provide different intensities of heat. The heaters 54A, 54B, 54C and 54D can be of the same intensities as the corresponding heaters 52A, 52B, 52C, 52D in the corresponding row A, B, C, D, or can be of different intensities.

FIG. 1 shows the belt drive system 50 positioned beneath the belts 40A-46D. The belt drive system 50 can be positioned within the housing 12 if the belt drive system 50 is made of materials able to withstand high temperatures. Alternatively, the belt drive system 50 can be outside of the housing 12 in which case roller shafts 68 on which the belts rotate will extend through the walls of the housing 12 to connect with the belt drive system 50.

The belt drive system 50 includes separate motors 60A, 60B, 60C, 60D driving each of the rows A, B, C, D of belts. In the side view of FIG. 1, only the outermost belts 46A, 46B, 46C, 46D adjacent side 58 are visible. Each motor 60A, 60B, 60C, 60D has a motor shaft 61A, 61B, 61C, 61D on which a drive pulley 62A, 62B, 62C, 62D is mounted for rotation with the motor shaft 61A, 61B, 61C, 61D. A controller 63 and a power source 65 are operatively connected to the motors 60A-60D such as by transfer conductors (not shown) operatively connected to the motors 60A, 60B, 60C, 60D to control power to and the speed of each of the motors 60A-60D. Drive belts 64A, 64B, 64C, 64D connect the drive pulleys 62A, 62B, 62C, 62D to driven pulleys 66A, 66B, 66C, 66D that are mounted on roller shafts 68 that turn the respective belts 46A, 46B, 46C, 46D. Each belt 46A, 46B, 46C, 46D has a roller shaft 68 at either end of the looped belt. In FIG. 5, each roller shaft 68 extends through each belt 40A-46B in the same row A, B, C, or D. Alternatively, instead of roller shafts 68, geared connections can be used between adjacent belts in the same row A, B, C, D, allowing the adjacent belts in the same row to rotate at different speeds than one another and than the belts in other rows. In yet another alternative option, each belt of every row A, B, C, D can be driven by a separate motor similar to motors 60A, 60B, 60C, and 60D so that there are sixteen separate motors. Still further, each set of belts in series with one another could be driven by a single motor if geared connections extend from shafts adjacent the ends of the belts and each belt on the same row has separate shafts rather than common roller shafts 68 extending through all belts in a row. In that case, the belts 40A, 40B, 40C, 40D would be driven by one motor, the belts 42A, 42B, 42C, 42D would be driven by a second motor, the belts 44A, 44B, 44C, 44D would be driven by a third motor, and the belts 46A, 46B, 46C, 46D would be driven by a fourth motor.

The furnace 10 also has a plurality of nozzles 70A, 70B supported by the housing 12. The nozzles 70A, 70B are positioned to dispense fluid toward the belts to quench the material within material sample containers traveling through the interior chamber 14, such as material sample container 48B shown in FIG. 1. In one embodiment, four nozzles 70A (one shown in FIG. 1) are spaced from one another in a row such that each of the nozzles 70A is positioned above a different one of the belts 40D, 42D, 44D, 46D. Four nozzles 70B are supported by the housing 12 and positioned to dispense fluid toward the underside of the belts 40D, 42D, 44D, 46D and the material containers. The nozzles 70B are shown in phantom in FIG. 5 as they are below the belts 40D, 42D, 44D, 46D. The nozzles 70A are not visible in the cross-sectional view of FIG. 5, but can be positioned directly above the belts 40D, 42D, 44D, 46D and aligned with the four nozzles 70B, respectively. The nozzles 70A, 70B may be configured so that fluid flows through different ones of the nozzles 70A, 70B at different flow rates. For example, the tips of the nozzles 70A, 70B may have different diameters. Fluid flowing through the first nozzle 70A toward belt 46D may have a different flow rate than fluid flowing through a second nozzle 70A toward belt 44D, or through nozzle 70B toward belt 46D.

A fluid distribution system 72 includes fluid supply lines 74 (one shown) that distribute fluid from a fluid supply 75 to the nozzles 70A. The fluid can be water, nitrogen, oil, or another fluid. The fluid can range in temperature, such as from 2 degrees Kelvin (K) to 1000K, with different temperature fluids provided to different ones of the nozzles 70A, 70B. Fluid supply lines 76 (one shown) distribute fluid from the fluid supply 75 to four nozzles 70B (one shown in FIG. 1) that are spaced from one another in a row such that each of the nozzles 70B is positioned below the belts 40D, 42D, 44D, 46D. The belts 40D, 42D, 44D, 46D may be a porous mesh or linked material to allow the fluid to pass through the belts 40D, 42D, 44D, 46D from the nozzles 70B to reach the material sample containers 48.

Accordingly, the fluid distribution system 72 may be configured to supply different fluids to different ones of the nozzles 70A, 70B. Alternatively or in addition, the fluid supply system 72 may supply fluid to different ones of the nozzles 70A, 70B at different pressures. For example, the four nozzles 70B positioned below the belts 40D, 42D, 44D, 46D may be configured so that fluid exits the nozzle 70B below belt 40D at a different pressure or a different flow rate than fluid exiting the nozzle 70B below belt 42D. A material sample container on belt 40D will be quenched differently than a material sample container on belt 42D under any of these circumstances.

The temperature profile of the material samples moving through the furnace 10 on the plurality of belts is determined in part by the quenching of the fluid distributed through the nozzles 70A, 70B, and in part by the speeds of the belts and the intensity of the heaters 52A-52D, 54A-54D. The temperature profiles of material samples in containers moving through the interior chamber 14 along different series of the belts (i.e., belts 40A, 40B, 40C, 40D, or belts 42A, 42B, 42C, 42D, or belts 44A, 44B, 44C, 44D, or belts 46A, 46B, 46C, 46D) are different due to the different belt speeds, spacing from the heaters 52A-52D, 54A-54D, and the differences in quenching by fluid through the different nozzles 70A, 70B.

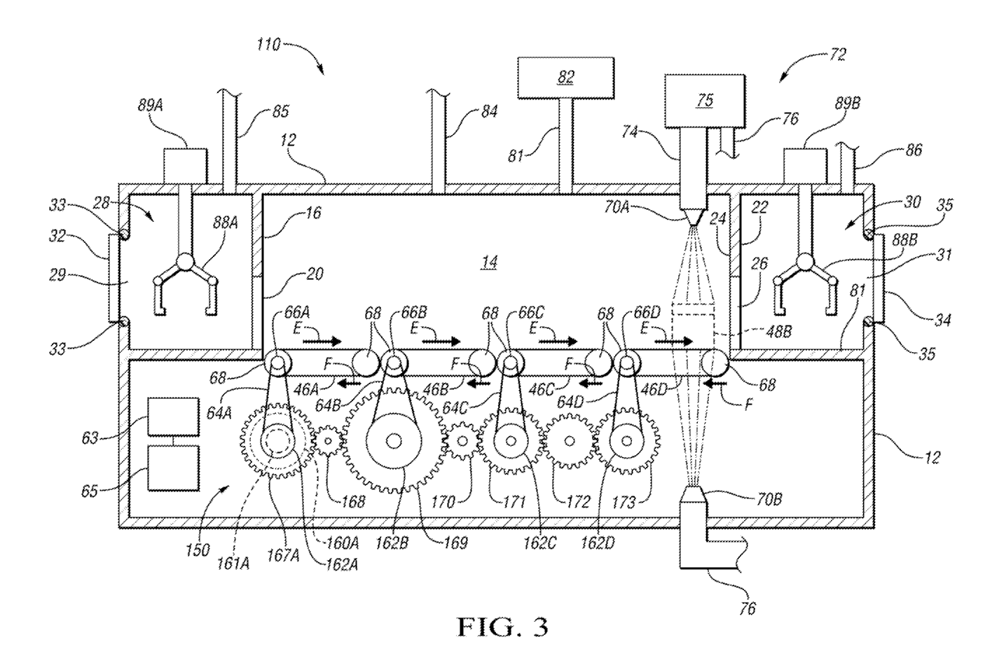

FIG. 3 shows another furnace 110 alike in all aspects to the furnace 10 of FIG. 1 except that a different belt drive system 150 is used. The belt drive system 150 has only a single motor 160A with a motor shaft 161A on which a drive gear 167A is mounted to rotate with the motor shaft 161A. A drive pulley 162A is also mounted to rotate with the motor shaft 161A and drives the belt 46A and the driven pulley 66A. The drive gear 167A is part of a gear train that also includes gear 168, gear 169, gear 170, gear 171, gear 172 and gear 173, each meshing with the adjacent gear or gears. Gears 169, 171 and 173 each have a respective drive pulley 162B, 162C and 162D mounted to rotate commonly therewith, and driving respective drive belts 46B, 46C, 46D and driven pulleys 66B, 66C, 66D. The gears 168, 170 and 172 are idler gears that enable each gear 169, 171, and 173 to rotate in the same direction as gear 167A. The speeds of the belts 46A, 46B, 46C and 46D are dependent on the gear ratio from the drive gear 167A to the respective driven pulley 66A, 66B, 66C, 66D through the gear train and the respective pulley and drive belt arrangement. As with the embodiment of FIG. 1, each belt 46A, 46B, 46C, 46D has a separate roller shaft 68 at either end of the looped belt. Alternatively, geared connections can be used between adjacent belts in the same row A, B, C, D, allowing the adjacent belts in the same row to rotate at different speeds than one another and than the belts in the other rows. In yet another alternative option, each belt of every row A, B, C, D can be driven by a separate motor similar to motor 160A, so that there are sixteen separate motors. Still further, each set of belts in series with one another could be driven by a single motor if geared connections extend from shafts adjacent the ends of the belts and each belt on the same row has separate shafts rather than common roller shafts 68 extending through all belts in a row. In that case, the belts 40A, 40B, 40C, 40D would be driven by one motor, the belts 42A, 42B, 42C, 42D would be driven by a second motor, the belts 44A, 44B, 44C, 44D would be driven by a third motor, and the belts 46A, 46B, 46C, 46D would be driven by a fourth motor (motor 160A).

Because the belts 40A-46D can be driven at different speeds by the belt drive 50 or the alternative belt drive 150, material samples passing through the interior chamber 14 are heat-treated according to a customized temperature profile while moving through the interior chamber 14 in parallel with one another.

Referring to FIG. 1, the process of heat-treating a material sample in the furnace 10 begins with opening the door 32 and loading the sealed material sample container 48 into the first antechamber 28 on a loading shelf 80. Although only one material sample container 48 is shown, multiple containers 48 would be placed in the antechamber 28 prior to closing the door 32. The door 32 is then closed. The interior chamber 14, and both antechambers 28, 30 are then purged by providing gas through a gas inlet port 81 from a gas supply 82 to the interior chamber 14, which forces the existing atmosphere out of outlets 84, 85, 86 placed in fluid communication with the interior chamber 14 and antechambers 28, 30. Only one gas inlet port is shown. However, there may be multiple gas inlet ports, and the gas inlet ports may be located near the lower portion of the interior chamber 14 and/or the antechambers 28, 30 instead of at the upper portion as shown. The gas supply 82 may include multiple different gases to enable a desired atmosphere to be created in the housing 12. For example, air, oxygen, hydrogen, argon, or another gas can be used to establish an inlet atmosphere in the furnace 10. Valves, not shown, would be used to control the flow of gases through the ports 81, 84, 85, 86.

Once the desired atmosphere within the housing 12 is established, a first mechanism 88A, which may be a robotic arm, is controlled by a controller 89A to unseal each of the containers 48. Unsealing the containers 48 may require the first mechanism 88A to unscrew a sealing lid 49 on each of the containers 48, or otherwise expose the sample materials within the containers 48 to the atmosphere within the housing 12. The first mechanism 88A is then controlled to move each of the unsealed sample containers 48 onto one of the belts 40A, 42A, 44A, 46A of the first row A through one of the aligned openings 20. The material sample container is depicted as 48A once placed in the interior chamber as shown on belt 42A in FIG. 5. The controller 63 is used to establish desired speeds of the motors 60A-60D and thus the speeds of the belts 40A-46B. Depending on which of the belts 40A, 42A, 44A, 46A a container 48 is placed on, it will pass between the heaters 52A, 54A of row A at a speed determined by the belt it is placed on and at a distance from each of the heaters 52A, 54A also determined by the chosen belt. The container 48 then passes between each of the other heaters 52B, 54B, 52C, 54C, and 52D, 54D in rows B, C, D at a speed and distance determined by the series of belts it rests on.

Once any of the containers 48 reach the last row D of belts, as illustrated at 48B in FIG. 5, the fluid supply system 72 is controlled to dispense fluid through the nozzles 70A, 70B to quench the containers 48 at a desired rate. A second mechanism 88B shown in FIG. 1, which may be another robotic arm, is controlled by a controller 89B to reach through the different openings 26 to pull the containers 48 off of the belts 40D, 42D, 44D, 46D and place the containers 48 on an unloading shelf 80 in the second antechamber 30. The second mechanism 88B is configured to reseal the containers 48 by twisting a lid 49 to tighten the lid 49 to the container 48 or by another action. The furnace 10 can be purged of gas, if desired, prior to opening the second door 34. The second door 34 is then opened and the material sample containers 48 are removed. Material samples in the containers 48 will have different properties, such as different phases and micro-structures, due to the different temperature profiles established in the furnace 10. That is, each material sample has a temperature profile based in part on the temperature gradient in the furnace 10 to which the container 48 containing the material sample is subjected. Different temperature profiles are established as each material sample can be subjected to a different amount of time in the furnace 10 due to the different belt speeds, to the different intensities of heat from the heaters, and to the different flow rates, pressures, or fluids used for quenching the containers 48 and the material samples therein.

Material samples heat-treated in the furnace 110 of FIG. 4 are processed in the same manner as discussed with respect to the furnace 10, except that the controller 63 controls only motor 160A, with the relative belt speeds determined by the gear ratios in the belt drive 150.

While the best modes for carrying out the many aspects of the present teachings have been described in detail, those familiar with the art to which these teachings relate will recognize various alternative aspects for practicing the present teachings that are within the scope of the appended claims.

1. A furnace comprising:
a housing defining an interior chamber;
a plurality of endless rotatable devices within the interior chamber arranged in a series of rows with multiple ones of the endless rotatable devices in each of the rows;
multiple heaters within the interior chamber adjacent to the plurality of endless rotatable devices; and
a drive system operable to drive at least some of the endless rotatable devices at different speeds than others of the endless rotatable devices.

2. The furnace of claim 1, wherein the housing further defines a first and a second antechamber at opposing ends of the interior chamber.

3. The furnace of claim 2, further comprising:
a first wall substantially dividing the interior chamber and the first antechamber and defining a first set of openings between the interior chamber and the first antechamber;
a second wall substantially dividing the interior chamber and the second antechamber and defining a second set of openings between the interior chamber and the second antechamber;
a first door openable to allow access to the first antechamber and configured to be sealed to the housing when closed; and
a second door openable to allow access to the second antechamber and configured to be sealed to the housing when closed.

4. The furnace of claim 3, further comprising:
a first mechanism within the first antechamber configured to unseal a material sample container placed in the first antechamber and controllable to move the unsealed material sample container through a selected one of the openings of the first set of openings to a selected one of the endless rotatable devices in a first of the plurality of rows adjacent the first wall.

5. The furnace of claim 4, further comprising
a second mechanism within the second antechamber controllable to remove the material sample container from the interior chamber through a selected one of the openings of the second set of openings after the material sample container travels through the interior chamber along those ones of the endless rotatable devices substantially aligned in series with the selected one of the endless rotatable devices; and wherein the second mechanism is configured to seal the material sample container in the second antechamber.

6. The furnace of claim 1, further comprising:
a plurality of nozzles positioned within the interior chamber and operable to spray fluid generally toward the plurality of endless rotatable devices.

7. The furnace of claim 6, wherein at least some of the nozzles are above the plurality of endless rotatable devices and others of the nozzles are below the plurality of endless rotatable devices.

8. The furnace of claim 7, wherein at least some of the plurality of endless rotatable devices are configured to permit the sprayed fluid to pass through said at least some of the plurality of endless rotatable devices.

9. The furnace of claim 6, wherein a first of the plurality of nozzles is configured to dispense fluid at a first flow rate and a second of the plurality of nozzles is configured to dispense fluid at a second flow rate different than the first flow rate.

10. The furnace of claim 6, further comprising:
a fluid distribution system configured to supply a first fluid to one of the plurality of nozzles and a second fluid to another of the plurality of nozzles.

11. The furnace of claim 6, further comprising:
a fluid distribution system configured to supply fluid to one of the plurality of nozzles at a first pressure and to another of the plurality of nozzles at a second pressure different than the first pressure.

12. The furnace of claim 1, wherein the drive system includes:
only one single motor;
a driven pulley rotatable with one of the plurality of endless rotatable devices;
a drive belt operatively connecting the single motor to the driven pulley; and
a plurality of intermeshing gears operatively connecting the driven pulley to at least some other ones of the endless rotatable devices and configured to establish different speed ratios between at least some of the endless rotatable devices.

13. The furnace of claim 1, wherein the drive system includes:
multiple motors each of which is operatively connected to and drives at least one different one of the endless rotatable devices at a different respective speed.

14. The furnace of claim 1, wherein at least some of the heaters are configured to provide heat at a different intensity than others of the heaters.

15. A furnace for heat-treating material samples that are housed in material sample containers, comprising:
a housing defining an interior chamber, a first antechamber at one end of the interior chamber, and a second antechamber at an opposing end of the interior chamber;
a plurality of belts within the interior chamber arranged in a series of rows with multiple ones of the belts in each of the rows; wherein each belt is configured to support one of the material sample containers;
a first set of heaters within the interior chamber on one side of the series of rows of belts and a second set of heaters within the interior chamber on an opposing side of the series of rows of belts;
a plurality of nozzles configured to spray fluid at least generally toward at least one of the rows of belts; and
a drive system operatively connected to the plurality of belts and configured to drive at least some of the belts at different speeds than others of the belts to move the material sample containers through the housing at different speeds.

16. The furnace of claim 15, wherein the drive system includes:
only one single motor;
a driven pulley rotatable with one of the belts;
a drive belt operatively connecting the single motor to the driven pulley; and
a plurality of intermeshing gears operatively connecting the driven pulley to at least some other ones of the belts and configured to establish different speed ratios between the motor and at least some of the belts.

17. The furnace of claim 15, wherein the drive system includes:
multiple motors each of which is operatively connected to and drives at least one different one of the belts at a different respective speed.

18. The furnace of claim 15, wherein at least some of the nozzles are above the plurality of belts and others of the nozzles are below the plurality of belts.

19. The furnace of claim 15, wherein a first of the nozzles is configured to dispense fluid at a first flow rate and a second of the nozzles is configured to dispense fluid at a second flow rate different than the first flow rate.

20. The furnace of claim 15, wherein the housing further defines a first and a second antechamber at opposing ends of the interior chamber; and further comprising:
a first wall substantially dividing the interior chamber and the first antechamber and defining a first set of openings between the interior chamber and the first antechamber;
a second wall substantially dividing the interior chamber and the second antechamber and defining a second set of openings between the interior chamber and the second antechamber;
a first door openable to allow access to the first antechamber and configured to be sealed to the housing when closed;
a second door openable to allow access to the second antechamber and configured to be sealed to the housing when closed;
a first mechanism within the first antechamber configured to unseal one of the material sample containers placed in the first antechamber and controllable to move the unsealed material sample container through a selected one of the openings of the first set of openings to a selected one of the belts in a first of the plurality of rows adjacent the first wall; and
a second mechanism within the second antechamber controllable to remove the unsealed material sample container from the interior chamber through a selected one of the openings of the second set of openings after the material sample container travels through the interior chamber along those ones of the belts substantially aligned in series with the selected one of the belts; and wherein the second mechanism is configured to seal the material sample container in the second antechamber.
